(19) United States
(12) Patent Application Publication
(10) Pub. No.: US 2002/0164201 A1
(43) Pub. Date: Nov. 7, 2002

(54) Method and apparatus for butt-jointing profiles made of elastomeric material

(76) Inventors: Christian Lempfer, Rehburg-Loccum (DE); Sascha Winter, Springe (DE)

Correspondence Address: PRICE, HENEVELD, COOPER,, DEWITT & LITTON, 695 Kenmoor, S. E., P.O. Box 2567, Grand Rapids, MI, 49501, US

(21) Appl. No.: 10/107,739

(22) Filed: Mar. 27, 2002

(30) Foreign Application Priority Data
Apr. 6, 2001 (DE) 101 17 124.2

(51) Int. Cl. B25G 3/34

(52) U.S. Cl. 403/267

(57) ABSTRACT

A process for butt-jointing profiles or profile sections made of elastomeric material including providing profiles having cut surfaces in jointing areas, moving the profiles toward each other leaving a bonding gap between the cut surfaces, introducing a jointing material into the bonding gap, and moving the profiles even closer together until their cut surfaces come into bonding contact with the jointing material. The jointing material is introduced directly into the bonding gap in a viscous state, preferably extruded into the bonding gap as a film.

An apparatus for butt-jointing profiles or profile sections including a pair of clamps that can move toward each other and for receiving the profiles, and an extruder having an extruder die positioned to introduce jointing material into the bonding gap between cut surfaces of the profiles.

### BACKGROUND OF THE INVENTION

The present invention generally relates to a procedure for butt-jointing profiles that are made of elastomeric material to form profiled joints including, moving profile ends toward each other, leaving a bonding gap between cut surfaces of the profile ends, introducing jointing material into the bonding gap, and moving the profiles even closer together until the cut surfaces come into bonding contact with the jointing material. The present invention also relates to an apparatus for performing the described butt-jointing procedure.

Profiles of the kind in question here often are used in motor vehicle construction to seal windows, flaps, and doors or similar covers for holes in a motor vehicle chassis. Specifically, matching profiles or profile sections of various lengths are combined to follow a progression corresponding to the contour of a hole or a cover section sealing the hole, so that the profiles can be mounted tracing the outline or contour in a sealing area. This requires assembling profiles or profile sections into a seal or sealing frame, wherein assembly takes place by means of abutting corresponding ends of profiles or profile sections in jointing areas of the sealing frame. Cut surfaces of the profile ends of the profiles or profile sections are either joined perpendicular to the profile or profile sections or the cut surfaces are beveled and joined at a predetermined angle.

Various procedures are available for permanently bonding cut surfaces of profiles that are brought into contact with each other. In one simple procedure, jointing material used as an adhesive is introduced in the bonding gap between the cut surfaces, e.g., by correspondingly wetting the cut surfaces with liquid adhesive prior to assembly of the cut surfaces. However, this bonding method is not suitable for rapid execution on an industrial scale with high piece numbers, since each adhesive requires a longer or shorter setting time.

When using a profile or profile section of elastomeric material having thermoplastic properties, a butt joint also can be fabricated according to another procedure by melting the cut surfaces through exposure to heat and pressing the melted cut surfaces together, forming a weld once the jointing area has cooled. Such a jointing procedure also takes time and, additionally, regulated, controllable heat treatment which often only can be achieved with a correspondingly high outlay in terms of equipment and materials processing.

It also has already been proposed for bonding profiles that the jointing material take the form of inserts made out of a material that is easier to heat to the required welding temperature. According to this method, the profiles with interspersed pieces or inserts of jointing material between the profiles are pressed together in a plasticized or plastic state, so as to produce a solid butt joint after cooling. The time required for material processing (i.e., before the seal can be handled as a single piece) is also disadvantageous here, in that it takes time before the joint has cooled and hardened.

Accordingly, a method and apparatus are desired to solve the aforementioned problems.

### SUMMARY OF THE INVENTION

The present invention is an improvement over current methods and apparatus for butt jointing profiles because it can be quickly executed, hence resulting in adherence to short cycle times during manufacture. To achieve this and other advantages, and in accordance with the purpose of the invention as embodied and broadly described herein, the present inventive method for butt-jointing profiles of elastomeric material provides using elastomeric profiles having cut surfaces, moving the cut surfaces of the profiles toward each other, leaving a bonding gap between the cut surfaces, introducing jointing material in a viscous state directly into the bonding gap, and moving the profiles even closer together until their cut surfaces come into contact with the jointing material. Further, in accordance with the purpose of the invention as embodied and broadly described herein, the present inventive apparatus for butt-jointing profiles of elastomeric material provides a pair of movably arranged clamps that can move toward each other and that can receive the profiles so that cut surfaces of the profiles face each other, and an extruder including an extruder die for introducing jointing material into a bonding gap between the moved-together cut surfaces.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of an elastomeric profile having profile ends and an apparatus for receiving the profile ends before the profile ends are joined, and shows a first step for butt-joining profiles;

FIG. 2 is a perspective view of the profile and apparatus of FIG. 1 when jointing material is introduced into the bonding gap between the profile ends; and

FIG. 3 is a perspective view of the profile and apparatus of FIG. 1 after the apparatus has been closed to form a bond between the profile ends and jointing material.

### DETAILED DESCRIPTION OF THE PREFERRED EMBODIMENT

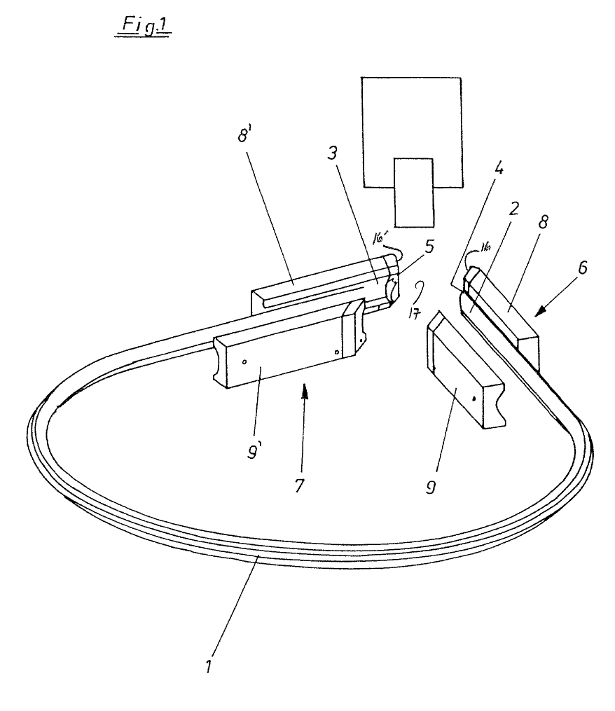

FIG. 1 shows a profile 1 including profile ends 2 and 3. Profile ends 2 and 3 have frontal cut surfaces 4 and 5, respectively. In the embodiment depicted in FIG. 1, cut surfaces 4 and 5 are miter cut, so that when cut surfaces 4 and 5 are joined together, profile ends 2 and 3 of profile 1 lie at an obtuse angle to each other.

FIG. 1 also shows clamps 6 and 7 (which are mounted on a device not shown in more detail here). Clamp 6 includes an insertion jaw 8 and a closing jaw 9. Clamp 7 includes an insertion jaw 8′ and a closing jaw 9′ which are identical to insertion jaw 8 and closing jaw 9.

Profile ends 2 and 3 of profile 1 are placed into insertion jaws 8 and 8′, respectively, so that frontal cut surfaces 4 and 5 of the profile ends 2 and 3 lie flush with front surfaces 16 and 16′ of the insertion jaws 8 and 8′, respectively. Such insertion can be performed manually, for example.

After profile ends 2 and 3 of the profile 1 have been placed in insertion jaws 8 and 8′ as described above, closing jaws 9 and 9′ can be placed against the insertion jaws 8 and 8′, respectively, so that the profile ends 2 and 3 of the profile 1 are mounted in and positively held by closed clamps 6 and 7. Actuators for closing clamps 6 and 7 also can be used.

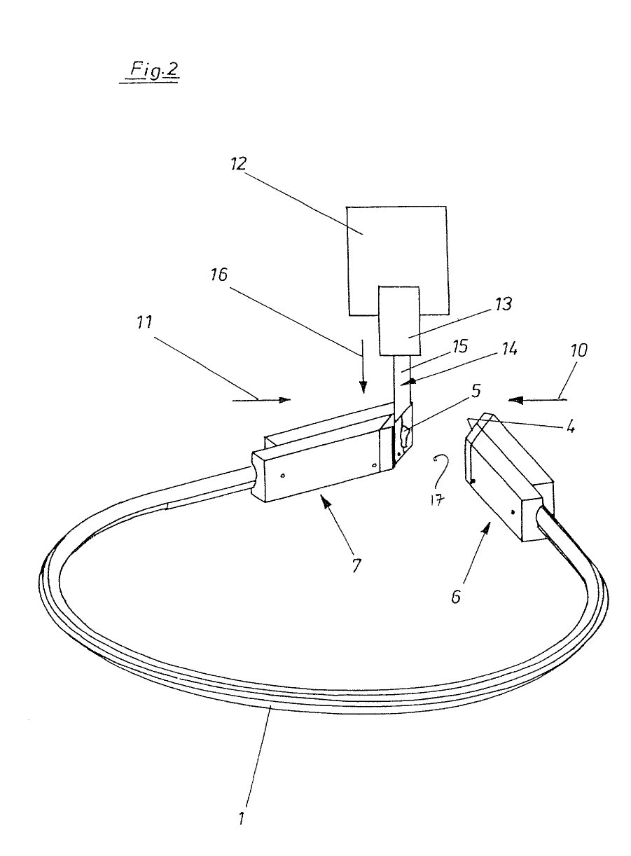

FIG. 2 shows profile 1 inserted in clamps 6 and 7, as previously described with respect to FIG. 1, in which profile ends 2 and 3 of profile 1 are mounted and closed in clamps 6 and 7, respectively.

Clamps 6 and 7 can be moved toward each other in the direction of the arrows 10 and 11, respectively (FIG. 2), so that frontal cut surfaces 4 and 5 of profile ends 2 and 3 which are held in clamps 6 and 7 can be brought into contact with each other. The position of clamp 6 relative to clamp 7 depicted in FIG. 2 corresponds to an open position, in which there is a bonding gap 17 between cut surfaces 4 and 5 that is relatively wide.

FIG. 2 also shows an extruder 12 with an outer extruder die ring 13 located so that its discharge spout lies over bonding gap 17 between the cut surfaces 4 and 5 of profile ends 2 and 3 located in closed clamps 6 and 7. Extruder 12, which also can be an injection unit, is used to introduce, e.g., press or squeeze, a liquid or pasty jointing material 14 into bonding gap 17 in the form of a material film 15. As shown in FIG. 2, material film 15 flows out of outer extruder die ring 13 into bonding gap 17 in the direction of the arrow 16, and is thereby positioned in front of and between frontal cut surfaces 4 and 5 of the profile ends 2 and 3 located in closed clamps 6 and 7. After material film 15 is positioned in front of frontal cut surfaces 4 and 5, clamps 6 and 7 are moved together in the direction of the arrows 10 and 11.

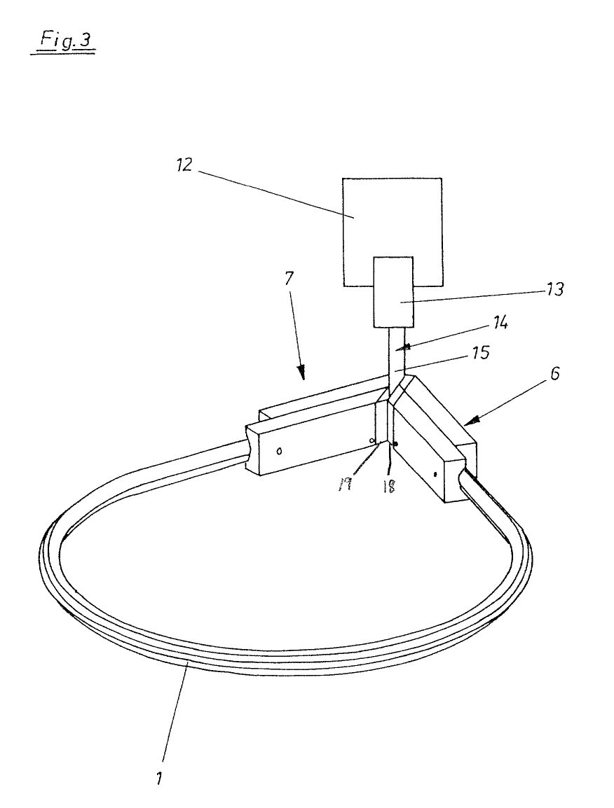

FIG. 3 depicts clamps 6 and 7 after they have been moved together. Moving together clamps 6 and 7 establishes a bond with film 15 of jointing material 14 located in bonding gap 17 between frontal cut surfaces 4 and 5, thus forming a one-piece sealing frame from profile 1.

Clamps 6 and 7 are designed so that when they are moved together, as shown on FIG. 3, cutters 18 and 19 on clamps 6 and 7 cut off the material film 15 to match the contour of profile 1, i.e., any portions of jointing material 14 that project over limiting edges of cut surfaces 4 and 5 of the profile 1 are cut away.

In the procedure according to the invention, jointing material is directly placed in a bonding gap between cut surfaces of ends of profiles (or profile sections) to be joined together. The jointing material can be provided in liquid form, and is directly introduced into the bonding gap, e.g., sprayed or extruded. The extrusion procedure is preferred, with the jointing material being extruded as a film from an extruder die ring of the extruder located in the area of the bonding gap. The material for fabricating the jointing material can be a plastic, e.g., thermoplastic elastomer, PVC or the like, which is still in more or less liquid or viscous form given the contact of the jointing material with the cut surfaces when the jointing material is directly introduced into the bonding gap. The advantage to this is that the cut surfaces of the profiles to be joined that border the bonding gap can also be supplied to the jointing procedure untreated, i.e., unprepared. Of course, a pretreatment with temperature or primers is also possible.

The jointing material extruded directly into the bonding gap replaces the insert platelets or insert films required in known procedures, which can also be drawn into the bonding gap via roller cartridges. In principle, a jointing material is only formed in the invention, e.g., into a film, during its introduction into the bonding gap and hence is not prefabricated, as is the case with the insert platelets or bonding films.

The procedure according to the invention is particularly suited for joining profiles consisting of any combination of materials desired, if necessary, even profiles with inserted reinforcements comprised of steel, aluminum or plastic. The procedure according to the invention makes it possible to smoothly bond profiles consisting of multiple parts, and hence encompassing any combination of profile materials desired, since bonding materials recognized as especially conducive to bonding with the given profile materials can be extruded directly into the bonding gap. For example, a thermoplastic elastomer can be used as the jointing material, since it is extremely conducive to bonding. The bonding conduciveness also can be influenced by the outlet temperature from the extruder, and/or the viscosity of the film and/or the thickness of the film extruded into the bonding gap.

As soon as the film consisting of jointing material has been pressed into the bonding gap, preferably extruded, the profiles are brought together until the cut surfaces have been joined by coming into contact with either side of the film consisting of jointing material. Each profile has a shape or outline that reflects the respective application, and the jointing material introduced in the form of a film projects outwardly from the shape or outline of the profile. Those sections of the jointing material projecting over limiting edges of the cut surfaces are cut off in the procedure according to the invention in one operation, before the profile sections which have been joined together to form a seal are passed along for further handling or use.

The procedure according to the invention is preferably suited to process different-colored jointing materials. The films extruded into the bonding gap also can be multi-layered, consisting of various, co-extruded layers. The jointing materials can be colored or transparent. Adjustments can be made to the respective application without any problem. Retrofit times for processing other jointing materials can be held down in an advantageous manner by keeping the extruder that processes the respectively desired jointing material on operational standby, and only operating their extruder heads, e.g., by way of valves, or, if needed, moving them into the area of the bonding gap to be treated, e.g., by means of a correspondingly activatable mechanism.

In addition to the advantageous feature that one element of the apparatus is designed as an extruder including an extruder die for directly introducing the jointing material into the bonding gap, the apparatus according to the invention also has as a special advantage clamps for joining together the profile sections, which clamps are equipped with cutters for executing a punched cut while bringing the clamps together. This combination enables an advantageous dual function of the clamps, since the clamps execute a punched cut when the cut surfaces of the profiles held in the clamps have moved together and established a bonding contact with the extruded film. This punched cut chips away the sections of the jointing material that project over limiting edges of the cut surfaces of the profiles, tailoring them to the shape and progression of the profile contours.

After the jointing material has set or hardened, the cut surfaces thus are joined together via the jointing material so that a seal, e.g., a one-piece sealing frame, can be removed from the apparatus.

It will be appreciated by those of ordinary skill in the art that the present invention can be applied to a wide variety of processes and apparatus for butt-jointing profiles in addition to those specifically mentioned here.

It will be understood by those who practice the invention and those of ordinary skill in the art, that various modifications and improvements may be made to the invention without departing from the spirit of the disclosed concept. The scope of protection afforded is to be determined by the claims and by the breadth of interpretation allowed by law.

The invention claimed is:

1. A method for butt-jointing profiles made of elastomeric material to form profiled joints, comprising:
providing profiles of elastomeric material having cut surfaces;
moving said cut surfaces of said profiles toward each other so as to leave a bonding gap between said cut surfaces;
introducing a viscous jointing material directly into said bonding gap; and
moving said cut surfaces of said profiles further toward each other until said cut surfaces come into bonding contact with said jointing material.

2. The method of claim 1, further including extruding said jointing material into said bonding gap.

3. The method of claim 2, wherein said jointing material is extruded into said bonding gap as a film.

4. The method of claim 2, wherein at least two jointing materials are co-extruded into said bonding gap.

5. The method of claim 1, wherein said jointing material is a thermoplastic elastomer.

6. The method of claim 1, wherein said cut surfaces of said profiles have limiting edges and sections of said jointing material project over said limiting edges, and further including cutting away said sections of said jointing material projecting over said limiting edges of said cut surfaces.

7. The method of claim 6, wherein said sections of said jointing material projecting over said limiting edges of said cut surfaces of said profile are cut away when said cut surfaces have moved together and established a bonding contact with said jointing material.

8. An apparatus for butt-jointing elastomeric profiles, comprising:
a pair of movably arranged clamps adapted to move toward each other, each said clamp configured to hold a profile having a contour and a cut surface, and positioned so that said cut surface of one held profile faces said cut surface of said other held profile, and
a device for introducing a jointing material into a bonding gap between said cut surfaces of profiles held in said clamps that have been moved toward each other, said device including an extruder and an extruder die aimed into said bonding gap.

9. The apparatus of claim 8, wherein said extruder die includes a slit through which said jointing material is extruded in the form of a film.

10. The apparatus of claim 8, wherein each said clamp has an insertion jaw and a closing jaw for engaging said insertion jaw to positively hold said profile.

11. The apparatus of claim 10, wherein said clamps have front surfaces that are flush with said cut surfaces that abut each other with said bonding gap closed, said clamps equipped with cutters whose shape and configuration match said contour of said profiles.
